(19) United States
(12) Patent Application Publication
(10) Pub. No.: US 2003/0069048 A1
(43) Pub. Date: Apr. 10, 2003

(54) Mobile phone receiver/transmitter and radio earphone receiver/transmitter

(76) Inventors: Jui-Yu Liu, Ping Chen City (TW); Yu-Liang Huang, Tao Yuan City (TW); Chia-Pin Wu, Chungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/972,979

(22) Filed: Oct. 10, 2001

(51) Int. Cl. H04M 1/00

(52) U.S. Cl. 455/569; 455/557; 455/550

(57) ABSTRACT

A mobile phone receiver/transmitter and radio earphone receiver/transmitter, wherein the mobile phone receiver/transmitter is built within or externally connected to the mobile phone and includes a power supply unit, an incoming call detector, a coder/decoder, a spread spectrum function module, a radio frequency circuit, a memory, a main controller and an off-hook/on-hook circuit. The radio earphone receiver/transmitter includes an earphone, a microphone, a control switch, an encoder/decoder, a spread spectrum function module, a radio frequency circuit, a memory unit and a main controller. Therefore, the radio communication is achieved by the mobile phone receiver/transmitter and the radio earphone receiver/transmitter by the spread spectrum function module.

### BACKGROUND OF THE INVENTION

(a) Field of the Invention

This invention relates to a mobile phone receiver/transmitter and a radio earphone receiver/transmitter, particularly to a radio earphone communication device involving with the spread spectrum signal processing.

(b) Description of the Prior Art

A conventional mobile phone is usually used with direct contacting with the user's cheek. It would be very inconvenient when driving an automobile or a motorcycle. Furthermore, the high-frequency power and electromagnetic fields created by the mobile phone during communication may harm users significantly and that is why the earphone kits with earphone cords have been available for a while. But the earphone and the microphone are connected to the mobile phone unit by at least one communication cord and therefore the use of the communication cord may bring inconveniences also like the tangled communication cord or the insensitive contact between the communication cord and the mobile phone or the earphone.

### SUMMARY OF THE INVENTION

The primary objective of the invention is to provide a mobile phone receiver/transmitter and a radio earphone receiver/transmitter for avoiding threats of electromagnetic waves and increasing its interference resistance ability by the spread spectrum function module. The second objective of the invention is to provide a mobile phone receiver/transmitter and a radio earphone receiver/transmitter for creating a new ID code for confidentiality while the mobile phone is being charged.

[Characteristics of the Invention]

To achieve the above objectives, the present invention provides a mobile phone receiver/transmitter that is built within or externally connected to a mobile phone. The mobile phone transmitter/receiver includes a power supply unit, an incoming call detector, an encoder/decoder, a spread spectrum function module, a radio frequency circuit, a memory unit, a main controller and an off-hook/on-hook circuit. The power supply unit provides powers to other elements of the mobile phone receiver/transmitter and is chargeable. The incoming call detector is connected to the mobile phone for detecting the call state of the mobile phone and generating a incoming call signal while detecting an incoming call. The encoder/decoder is connected to the mobile phone and to process an analog-to-digital/digital-to-analog conversion and a linear encoding/decoding for the input signals. A spread spectrum function module, connected to the encoder/decoder, is to provide a spread spectrum process for the input signals. A radio frequency circuit, connected to the spread spectrum module, is to transmit signals from the spread spectrum function module or to input the signals to the spread spectrum module. A memory unit, connected to the spread spectrum function module, is to store ID codes and other settings generated by the spread spectrum function module. A main controller, connected to the incoming call detector and the spread spectrum function module, is to activate the spread spectrum function module and the radio frequency circuit while receiving the incoming call signal. An off-hook/on-hook circuit, connected to the main controller, is to transmit an off-hook signal or an on-hook signal to the mobile phone. The present invention also provides a radio earphone receiver/transmitter, including an earphone, a microphone, a power supply unit, a control switch, an encoder/decoder, a spread spectrum function module, a radio frequency circuit, a memory unit, and a main controller. The power supply unit is to provide powers to all other elements and is a chargeable power source. The control switch is to generate an off-hook/on-hook signal while being pressed by a user. The encoder/decoder, connected to the earphone and the microphone, is to provide an analog-to-digital/digital-to-analog conversion and a linear encoding/decoding for input signals. The spread spectrum function module, connected to the encoder/decoder, for providing a spread spectrum process for the input signals. The radio frequency circuit, connected to the spread spectrum function module, is to transmit signals from the spread spectrum function module or to input the signals to the spread spectrum function module. The memory unit, connected to the spread spectrum function module, is to store ID codes and settings generated by the spread spectrum function module. The main controller, connected to the control switch and the spread spectrum function module, is to receive the off-hook/on-hook signal generated from the control switch and to input the off-hook/on-hook signal to the spread spectrum function module for activating the radio frequency circuit.

It is an advantage of the present invention that a wireless communication can be set up between the mobile phone transmitter/receiver and the earphone transmitter/receiver, and the signals can be processed by the spread spectrum function module to avoid interferences. Furthermore, the communication cords for connecting the mobile phone and the earphone are not necessary so as to avoid insensitivity contact between the communication cord and the mobile phone or the earphone.

These and other objectives of the present invention will no doubt become obvious to those ordinary skill in the art after reading the following detailed description of the preferred embodiment which is illustrated in the various figures and drawings.

### BRIEF DESCRIPTION OF DRAWINGS

The following and other features and advantages of the present invention will be more easily understood from the following detailed description and the accompanying drawings, in which,

FIG. 1 is a schematic diagram while using a mobile phone receiver/transmitter of the present invention.

FIG. 2 is a schematic diagram while using a radio earphone transmitter/receiver of the present invention.

FIG. 3 is a block diagram of the mobile phone receiver/transmitter of the present invention.

FIG. 4 is a block diagram of a spread spectrum function module of the present invention mobile phone transmitter/receiver.

FIG. 5 is a block diagram of the radio earphone transmitter/receiver of the present invention.

FIG. 6 is a block diagram of a spread spectrum function module of the present invention radio earphone transmitter/receiver.

FIG. 7 is a schematic diagram while charging the mobile phone transmitter/receiver and the radio earphone transmitter/receiver of the present invention.

FIG. 8 is a block diagram while charging the mobile phone receiver/transmitter and the radio earphone receiver/transmitter.

### DETAILED DESCRIPTION OF PREFERRED EMBODIMENTS

For the better understanding of the technology, technical approach, and anticipated performance and objectives of the present invention, please refer to the detailed description and drawings as follows.

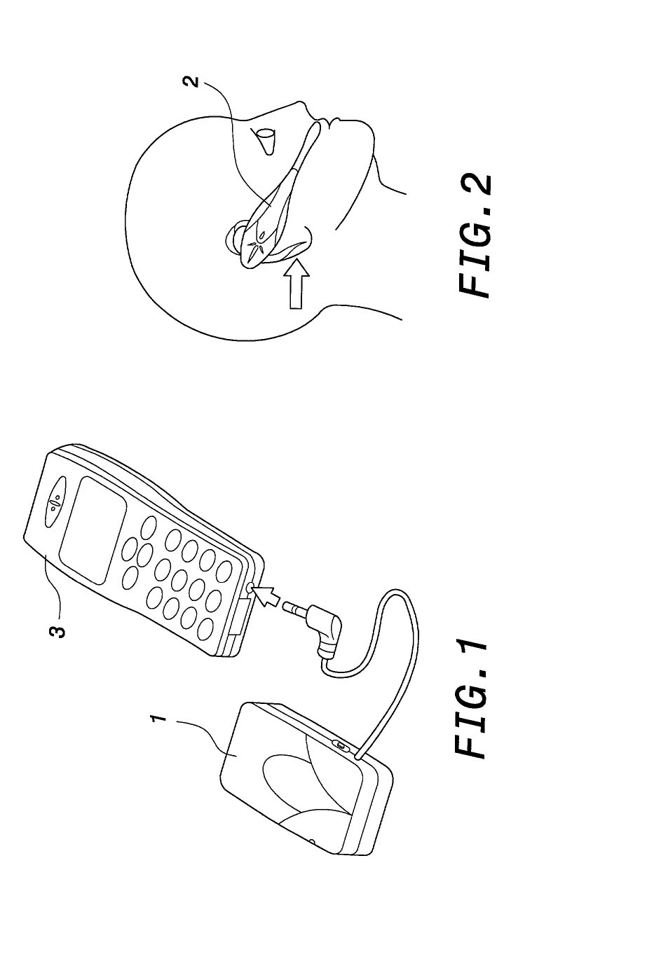

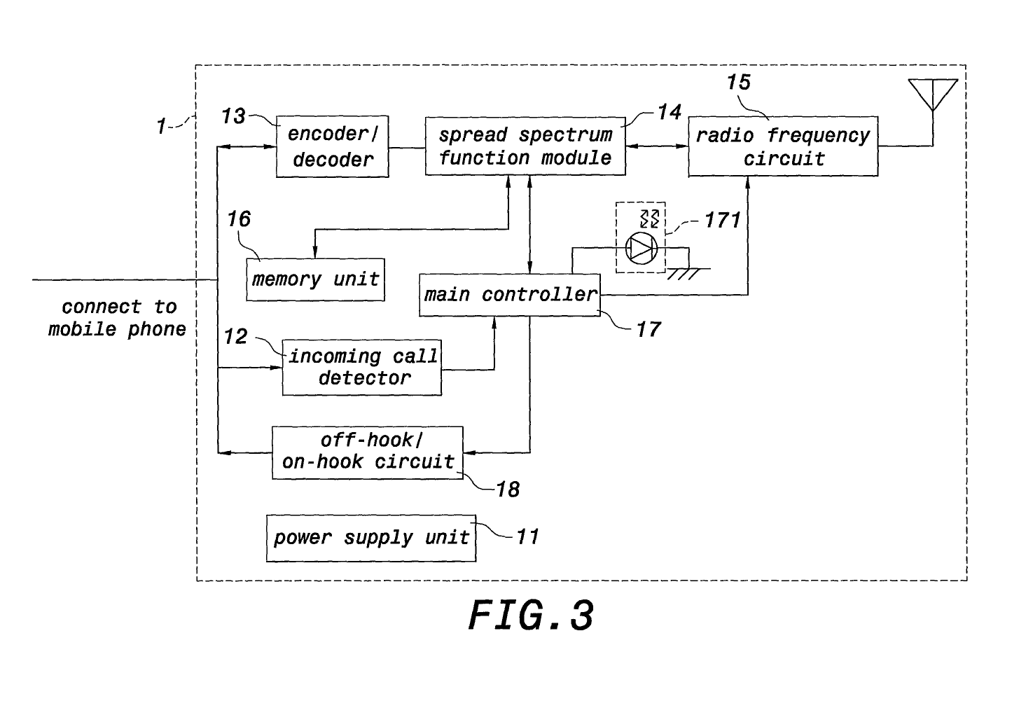

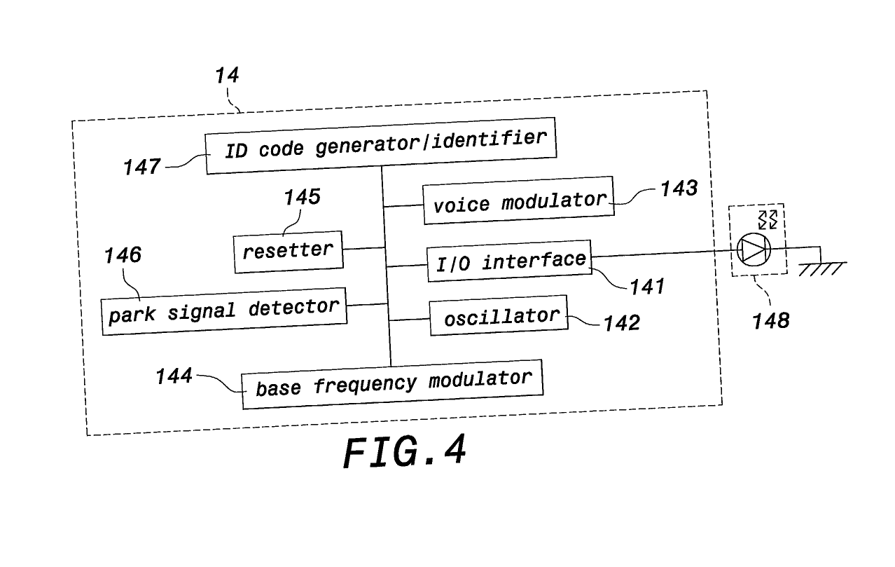

As shown in FIGS. 1 and 2, the present invention consists of a mobile phone receiver/transmitter 1 and a radio earphone receiver/transmitter 2. The mobile phone receiver/transmitter 1 is connected externally to a mobile phone 3 or built within the mobile phone 3. FIG. 3 shows a block diagram of the mobile phone receiver/transmitter 1. The mobile phone receiver/transmitter includes a power supply unit 11, an incoming call detector 12, an encoder/decoder 13, a spread spectrum function module 14, a radio frequency circuit 15, a memory unit 16, a main controller 17 and an off-hook/on-hook circuit 18. The power supply unit 11 is supplied by a chargeable battery and can be substituted by an alkaline battery and provides powers to all elements of the mobile phone receiver/transmitter 1. The incoming call detector 12 is connected to the mobile phone 3, serves to detect a call state of the mobile phone 3, and generates an incoming call signal while detecting an incoming call. The encoder/decoder 13 is connected to the mobile phone 3 to process an analog-to-digital/digital-to-analog conversion and a linear encoding/decoding for input signals. As shown in FIG. 4, the spread spectrum function module 14 is connected to the encoder/decoder 13. The spread spectrum function module 14 further includes an I/O interface 141, an oscillator 142, a voice modulator 143, a base frequency modulator 144, a resetter 145, a park signal detector 146, and an ID code generator/identifier 147. The I/O interface 141 is connected to a light-emitting diode 148 that serves to indicate the mode of voice communication. The oscillator 142 provides an oscillation frequency of 9.6 MHz.

The voice modulator 143 provides an adaptation differential pulse code modulation (ADPCM) and a demodulation. The base frequency modulator 144 is able to convert parallel data to serial data and to provide a scramble/descramble, a spread spectrum/de-spread spectrum process, a time division multiplexing control, a data time recovery, an automatic frequency correction (AFC), an automatic gain control (AGC), and an automatic control rate adaptation. The resetter 145 is for resetting spread spectrum function module 14. The park signal detector 146 is for detecting if there is a park signal or not. The ID code generator/identifier 147 generates and identifies the ID codes.

Please go back to FIG. 3, the radio frequency circuit 15 is connected to the spread spectrum function module 14 to transmit the input signals of the spread spectrum function module 14, or to input signals to the spread spectrum function module 14.

The memory unit 16, optionally an electronic erasable program read-only memory, is connected to the spread spectrum function module 14 and stores the ID codes and other settings generated by the ID code generator/identifier 147 of the spread spectrum function module 14. The main controller 17 is connected to the incoming call detector 12 and the spread spectrum function module 14. While receiving the incoming call signal from the incoming call detector 12, the main controller 17 activates the spread spectrum function module 14 and the radio frequency circuit 15. The main controller 17 is further connected with a light-emitting diode 171 for being a low-electricity indicator.

The off-hook/on-hook circuit 18 is connected to the main controller 17. Controlled by the main controller 17, the off-hook/on-hook circuit 18 is able to generate an off-hook or an on-hook signal to the mobile phone 3.

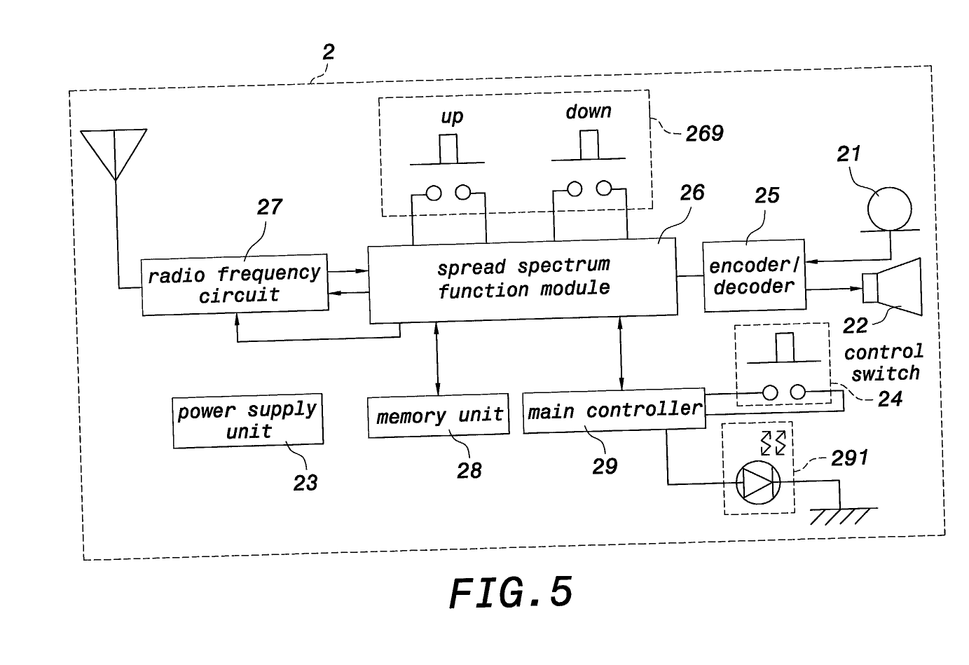

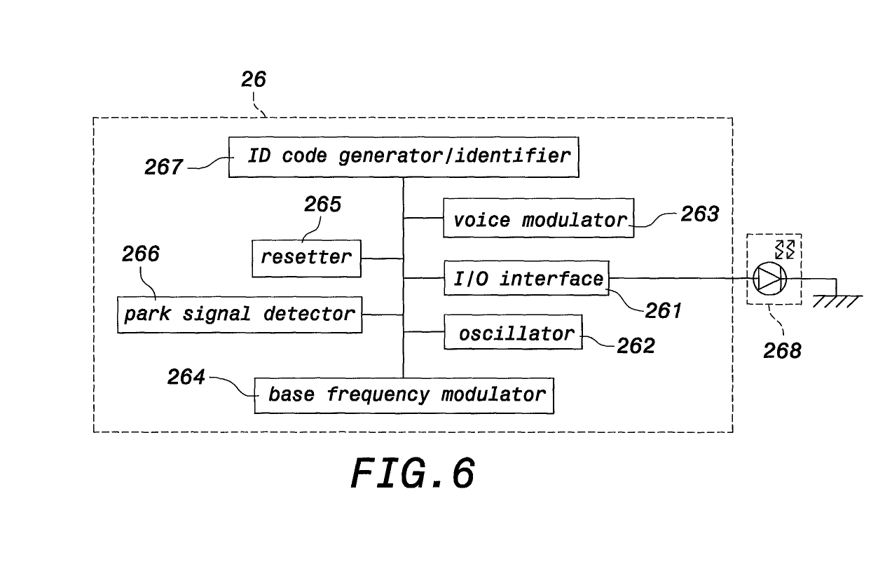

FIG. 5 illustrates the block diagram of the radio earphone receiver/transmitter 2. The radio earphone receiver/transmitter 2 includes an earphone 21, a microphone 22, a power supply unit 23, a control switch 24, an encoder/decoder 25, a spread spectrum function module 26, a radio frequency circuit 27, a memory unit 28, and a main controller 29. The power supply unit 23 is a power source of the radio earphone receiver/transmitter 2, and its power is supplied by a chargeable battery and can be substituted by an alkaline battery. The control switch 24 generates an off-hook/on-hook signal while being pressed by a user. The encoder/decoder 25, connected to the earphone 21 and a microphone 22, is to provide an analog-to-digital/digital-to-analog conversion and a linear encoding/decoding for the input signals. As shown in FIG. 6, the spread spectrum function module 26 is connected to the encoder/decoder 25. The spread spectrum function module 26 includes an I/O interface 261, an oscillator 262, a voice modulator 263, a base frequency modulator 264, a resetter 265, a park signal detector 266, and an ID code generator/identifier 267, all of which are with the same function comparing with their counterparts in the spread spectrum function module 14 of the mobile phone receiver/transmitter 1.

The I/O interface 261 of the spread spectrum function module 26 is connected to a light emitting diode 268 to indicate a voice communication mode, and is connected to two voice volume keys 269 for the adjustment of voice volume.

The radio frequency circuit 27, connected to the spread spectrum function module 26, is activated by the spread spectrum function module 26 to transmit the signals from the spread spectrum function module 26 or input the signals to the spread spectrum function module 26. The memory unit 28, optionally an electronic erasable program read-only memory, is connected to the spread spectrum function module 26 and stores the ID codes and other settings generated by the ID code generator/identifier 267 of the spread spectrum function module 26. The main controller 29, connected to the control switch 24 and the spread spectrum function module 26, serves to receive the off-hook/on-hook signal generated when the control switch 24 is pressed and to input the signals to the spread spectrum function module 26. The main controller 29 is connected to a light emitting diode 291 for being a low-electricity indicator.

Generally speaking, the mobile phone receiver/transmitter 1 is always at an energy-saving mode if no incoming call. When there is an incoming call to the mobile phone 3, the incoming call detector 12 generates an incoming call signal to the main controller 17. The main controller 17 activates the spread spectrum function module 14 and the radio frequency circuit 15 thereafter. Then, the radio frequency circuit 15 transmits a signal to the radio frequency circuit 27 of the radio earphone receiver/transmitter 2.

The radio earphone receiver/transmitter 2 can be set at a manual in-line mode or an automatic in-line mode alternatively. When set at a manual in-line mode, the user decides whether to establish the connection between the mobile phone receiver/transmitter 1 and the earphone receiver/transmitter 2 or not. That is, if the user hears the rings of an incoming call, he or she has to press the control switch for generating a signal to the main controller 29. The main controller 29 controls the spread spectrum function module 26 to activate the radio frequency circuit 27. Therefore, the radio frequency circuit 27 is able to communicate with the radio frequency circuit 15 of the mobile phone receiver/transmitter 1 for transmitting and receiving signals. Meanwhile, the spread spectrum function module 14 requests the main controller 17 to control the off-hook/on-hook circuit 18 for generating an on-hook signal to the mobile phone 3. When set at the automatic in-line mode, establishing the connection between the mobile phone receiver/transmitter 1 and the radio earphone receiver/transmitter 2 is determined by the radio frequency circuit 27 of the radio earphone receiver/transceiver 2. The radio frequency circuit 27 is switched to an energy-saving mode if no incoming call, activated periodically for detecting if there is an incoming call or not, and back to the energy-saving mode after detecting no incoming signal. If an incoming call is detected, the radio frequency circuit 27 is activated by the spread spectrum function module 26 for communicating with its counterpart, the radio frequency circuit 15, of the mobile phone receiver/transmitter 1. It is noted that the main controller 17 itself does not send on-hook signals to the mobile phone 3. The communication is set up by the auto answering function of the mobile phone 3 or by pressing key manually. Once the connection between the mobile phone receiver/transmitter 1 and the radio rear phone receiver/transmitter 2 is set up, the analog voice signals from the mobile phone 3 can be fed to the encoder/decoder 13 of the mobile phone receiver/transmitter 1 for being processed the analog-to-digital conversion and the linear encoding and then being input to the spread spectrum function module 14. The voice modulator 143 of the spread spectrum function module 14 converts the signals after the analog-to-digital conversion and the linear encoding to pulse codes, then the base frequency modulator 144 converts them to the adaptation differential pulse code modulation (ADPCM) signals. After several kinds of other process, like converting parallel data to serial data and the data scramble/descramble, in wake of confidentiality, outcome signals of these process will be input to the radio frequency circuit for transmitting out. While the outcome signals are received by the radio frequency circuit 27, they are input to the spread spectrum function module 26, which is able to provide the de-spread spectrum process and the data descramble process for them and to convert the serial data to the parallel data. Analog signals will be restored on the earphone 21 after signal processing by the voice modulator 263 and the encoder/decoder 25 on the heels of the de-spread spectrum process, the data descramble process, and the converting from the parallel data to the serial data. The aforementioned process combination for restoring analog signals can also be applied to the input signals of the microphone 22.

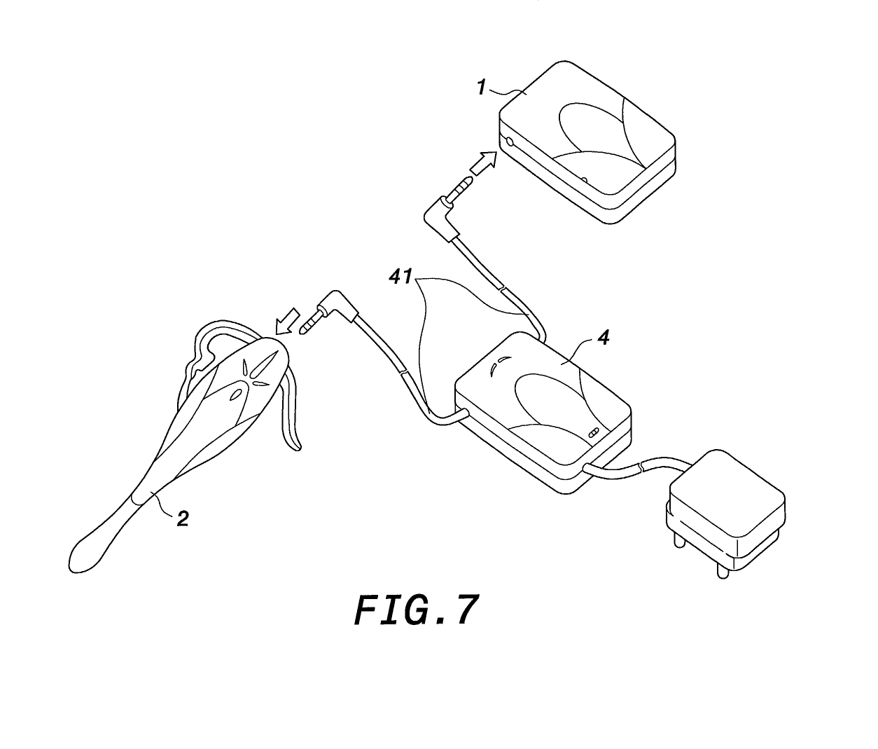

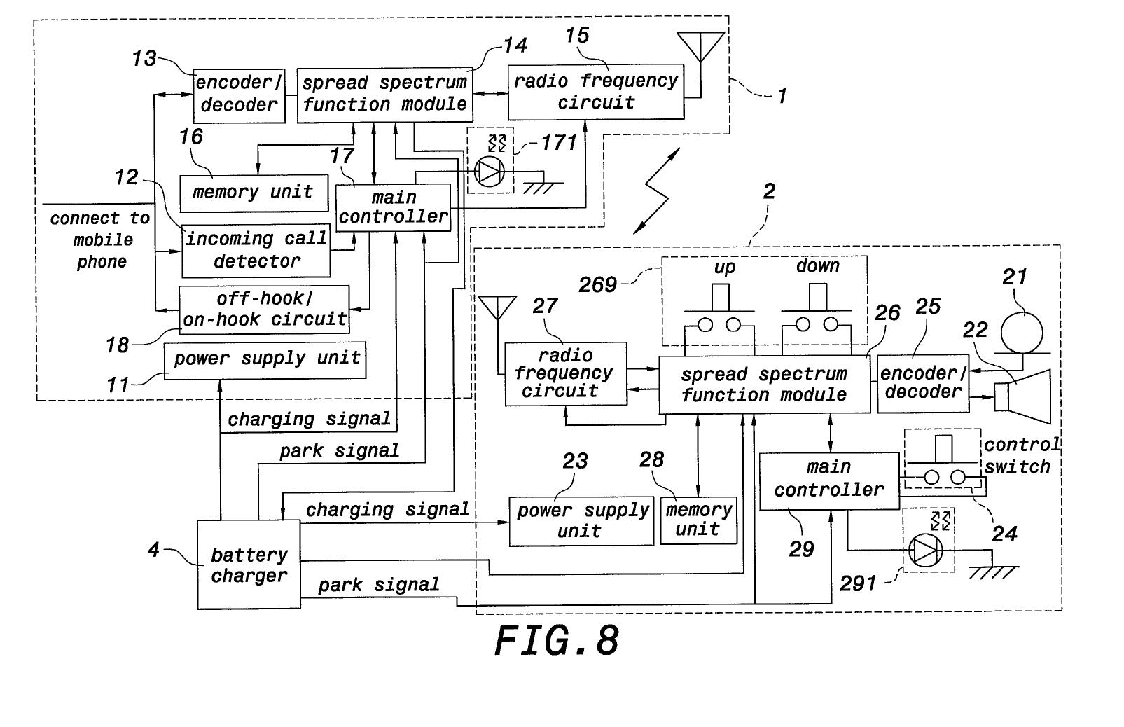

If the communication to be ended, the user can press the control switch 24 of the radio earphone receiver/transceiver 2 for generating the off-hook signal to the main controller 29. After that, the off-hook signal is processed by the spread spectrum function module 26, transmitted to the radio frequency circuit 15 of the mobile phone receiver/transmitter 1 by the radio frequency circuit 27 thereafter, and processed by the spread spectrum function module 14. At last, the off-hook signal, generated by the off-hook/on-hook circuit 18, is sent to the mobile phone 3 for ending the communication. Of course, ending communication can be executed by pressing the off-hook key of the mobile phone 3. Please refer to FIG. 7, a battery charger 4 with the alternative voltage input like 110 volts or 220 volts is able to charge the mobile phone receiver/transmitter 1 and the radio earphone receiver/transmitter 2 respectively by a charging cable 41. As shown in FIG. 8, the battery charger 4 respectively sends charging signals to the main controller 17, 29, which control the power supply unit 11, 23. Meanwhile, the battery charger 4 sends a park signal to the main controller 17 and the spread spectrum function module 14 of the mobile phone receiver/transmitter 1. The main controller 17 then requests the ID code generator/identifier 147 of the spread spectrum function module 14 to generate a new ID code. Then, the charging cable 41 of the battery charger 4 transmits another park signal to the main controller 29 and the spread spectrum function module 26 of the radio earphone receiver/transmitter 2. The main controller 29 then requests the ID code generator/identifier 267 of the spread spectrum function module 26 to generate a new ID code as same as the ID code generated by the spread spectrum function module 14. In the aftermath of generating the ID codes, the radio frequency circuit 27 transmits the ID codes to the mobile phone receiver/transmitter 1 to be confirmed by the ID code generator/identifier 147 of the spread spectrum function module 14. The confirmation results can be sent back to the ID code generator/identifier 267 of the radio earphone receiver/transmitter 2 and then the ID codes can be stored in the memory units 16 and 28. After completing charging, these ID codes will accompany with the signals transmitted or received thereafter for further processing of encryption.

Therefore, the present invention of mobile phone receiver/transmitter 1 and radio earphone receiver/transmitter 2 provide a radio frequency at 900 MHz or 2.4 GHz with powerful resistance to interferences, wiretappings and electromagnetic waves. Therefore, this application is duly filed in accordance with the Patent Law. Your favorable consideration shall be appreciated.

Although the present invention has been illustrated and described with reference to the preferred embodiment thereof, it should be understood that it is in no way limited to the details of such embodiment but is capable of numerous modifications within the scope of the appended claims.

What is claimed is:

1. A mobile phone receiver/transmitter, optionally built within or externally connected to a mobile phone, comprising:
a power supply unit for serving as a chargeable power source;
an incoming call detector, connected to the mobile phone, for detecting a call state of the mobile phone and generating an incoming call signal while detecting an incoming call;
an encoder/decoder, connected to the mobile phone, for processing an analog-to-digital/digital-to-analog conversion and a linear encoding/decoding for input signals;
a spread spectrum function module, connected to the encoder/decoder, for providing the input signals a spread spectrum process;
a radio frequency circuit, connected to the spread spectrum module, for transmitting signals from the spread spectrum function module or inputting the signals to the spread spectrum module;
a memory unit, connected to the spread spectrum function module, for storing ID codes and settings generated by the spread spectrum function module;
a main controller, connected to the incoming call detector and the spread spectrum function module, for activating the spread spectrum function module and the radio frequency circuit while receiving the incoming call signal; and
an off-hook/on-hook circuit, connected to the main controller, for transmitting an off-hook signal or an on-hook signal to the mobile phone.

2. The mobile phone receiver/transmitter as claimed in claim 1, wherein power of the power supply unit is supplied by a chargeable battery and is substituted by an alkaline battery.

3. The mobile phone receiver/transmitter as claimed in claim 1, wherein the spread spectrum function module further comprises:
an I/O interface;
an oscillator for providing at least one oscillation frequency;
a voice modulator for providing a adaptation differential pulse code modulation (ADPCM) and a demodulation;
a base frequency modulator for converting parallel data to serial data and providing a scramble/descramble, a spread spectrum/de-spread spectrum process, a time division multiplexing control, a data timing recovery, an automatic frequency calibration (AFC), an automatic gain control (AGC), and an automatic control rate adaptation;
a resetter for resetting the spread spectrum function module;
a park signal detector for detecting if there is a park signal or not; and
an ID code generator/identifier for generating and identifying the ID codes.

4. The mobile phone receiver/transmitter as claimed in claim 3, wherein the I/O interface is connected to a light emitting diode for indicating a mode of vocal communication.

5. The mobile phone receiver/transmitter as claimed in claim 1, wherein the memory unit is an electronic erasable program read-only memory (EEPROM).

6. The mobile phone receiver/transmitter as claimed in claim 1, wherein the main controller is connected to a light emitting diode for being a low-electricity indicator.

7. A radio earphone receiver/transmitter, comprising:
an earphone;
a microphone;
a power supply unit for providing a chargeable power source;
a control switch for generating an off-hook/on-hook signal while being pressed by a user;
an encoder/decoder, connected to the earphone and the microphone, for providing an analog-to-digital/digital-to-analog conversion and a linear encoding/decoding for input signals; a spread spectrum function module, connected to the encoder/decoder, for providing a spread spectrum process on the input signals;
a radio frequency circuit, connected to the spread spectrum function module, for transmitting signals from the spread spectrum function module or inputting the signals to the spread spectrum function module;
a memory unit, connected to the spread spectrum function module, for storing ID codes and settings generated by the spread spectrum function module; and
a main controller, connected to the control switch and spread spectrum function module, for receiving the off-hook/on-hook signal generated from the control switch and inputting the off-hook/on-hook signal to the spread spectrum function module to activate the radio frequency circuit.

8. The radio earphone receiver/transmitter as claimed in claim 7, wherein the power of the power supply unit is provided by a chargeable battery and is substituted by an alkaline battery.

9. The radio earphone receiver/transmitter as claimed in claim 7, wherein the spread spectrum function module further comprising:
an I/O interface;
an oscillator for providing at least one oscillation frequency;
a voice modulator for providing an adaptation differential pulse code modulation (ADPCM) and a demodulation;
a base frequency modulator for converting parallel data to serial data and providing a scramble/descramble, a spread spectrum/de-spread spectrum, a time division multiplexing control, a data timing recovery, an automatic frequency calibration (AFC), an automatic gain control (AGC), and an automatic control rate adaptation;
a resetter for resetting the spread spectrum function module;
a park signal detector for detecting if there's a park signal or not; and
an ID code generator/identifier for generating and identifying the ID codes.

10. The radio earphone receiver/transmitter as claimed in claim 9, wherein the I/O interface is connected to a light emitting diode for indicating a mode of vocal communication.

11. The radio earphone receiver/transmitter as claimed in claim 9, wherein the I/O interface is connected to a plurality of sound volume keys.

12. The radio earphone receiver/transmitter as claimed in claim 7, wherein the memory unit is an electronic erasable program read-only memory (EEPROM).

13. The radio earphone receiver/transmitter as claimed in claim 7, wherein the main controller is connected to a light emitting diode for being a low-electricity indicator.
